(19) United States
(12) Patent Application Publication
(10) Pub. No.: US 2013/0278385 A1
(43) Pub. Date: Oct. 24, 2013

(54) DEVICE, SYSTEM AND METHOD OF PROCESSING A RECEIVED ALERT

(71) Applicants: Lonny Baskin, Tsur Hadassah (IL); Ariel Malamud, Jerusalem (IL)

(72) Inventors: Lonny Baskin, Tsur Hadassah (IL); Ariel Malamud, Jerusalem (IL)

(21) Appl. No.: 13/976,103

(22) PCT Filed: Aug. 29, 2011
(86) PCT No.: PCT/US11/49592

§ 371 Date: Jun. 26, 2013

(51) Int. Cl. G08B 27/00

(52) U.S. Cl. CPC G08B 27/00
USPC 340/7.51

(57) ABSTRACT

Some demonstrative embodiments include devices, systems and/or methods of processing alerts. For example, a device may include an alert module, operative independent of an operating-system and/or a power mode of the device, to receive an alert message from at least one communication network and to cause at least one user interface of the device to provide to a user of the device an alert indication, which is based on the alert message.

### BACKGROUND

An alert and/or warning system (“alert system”), e.g., an Emergency Alert System (EAS), may be configured to provide an alert to one or more recipients, e.g., to the public, to one or more private recipients, to a predefined group of recipients, and the like. The alert may include, for example, an emergency alert, e.g., a national emergency alert, a state emergency alert, a local alert, a territorial alert, a tribal alert, an official emergency alert, and the like. The alert may relate to any situation, event, incident, and the like, e.g., a terrorist attack, a natural disaster, a public safety hazard, and the like.

The alert may be generated by any entity, e.g., a government entity, a public entity, a private entity, and the like. In one example, the alert may be generated by the U.S. Dept of Homeland Security-Federal Emergency Management Agency (DHS-FEMA).

The alert system may include, or be implemented as part of, the Integrated Public Alert & Warning System (IPAWS).

In one example, the IPAWS may include a Commercial Mobile Alert System (CMAS), which may be configured to provide services to emergency operations centers, which in turn may warn the public through geographically targeted messages, e.g., using Commercial Mobile Service Providers (CMSPs).

The alert system may implement an alert protocol, for example, the Common Alerting Protocol (CAP). The CAP may allow an alert message to be consistently disseminated simultaneously over many warning systems to many applications. The CAP may increase warning effectiveness and/or simplify the task of activating a warning for responsible officials.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic flow-chart illustration of a method of processing an alert, in accordance with some demonstrative embodiments.

FIG. 3 is a schematic illustration of an article of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality” as used herein include, for example, “multiple” or “two or more”. For example, “a plurality of items” includes two or more items.

The terms “powering down” and “power down” as used herein with relation to a device, unit, element, module and/or a component may refer, for example, to reducing, diminishing, shutting down, powering off, turning off and/or switching off the electrical current to the device, unit, element, module and/or a component, and/or to switching the device, unit, element, module and/or a component to operate at a sleep mode, a reduced-power mode, a hibernate mode, a stand-by mode and/or any other operation mode which consumes less power than required for full and/or normal operation of the device, unit, element, module and/or a component. For example, powering down a computing device, e.g., a computing device which is configured to receive, handle, decode, authenticate and/or process an alert message, a component of a computing device, one or more hardware (HW) and/or software (SW) components of the computing device, and/or an Operating System (OS) of the computing device may include reducing, diminishing, shutting down, powering off, turning off and/or switching off the electrical current to the computing device, the component of the computing device, the one or more HW and/or software SW components of the computing device, and/or the OS of the computing device; and/or to switching the computing device, the component of the computing device, the one or more HW and/or software SW components of the computing device, and/or the OS of the computing device to operate at a sleep mode, a reduced-power mode, a hibernate mode, a stand-by mode and/or any other operation mode which consumes less power than required for full operation, e.g., for full reception, handling, decoding, authenticating and/or processing the alert message.

The terms “powering up” and “power up” as used herein with relation to a device, unit, element, module and/or a component may refer, for example, to enhancing, resuming, turning on and/or switching on the electrical current to the device, unit, element, module and/or a component, and/or to switching the device, unit, element, module and/or a component from sleep mode, stand by mode or any other operation mode, which consumes less power than required for full reception and/or normal operation of the device, unit, element, module and/or a component, and/or to switching the device, unit, element, module and/or a component, to operational mode. For example, powering up a computing device, e.g., a computing device which is configured to receive, handle, decode, authenticate and/or process an alert message, a component of a computing device, one or more HW and/or SW components of the computing device, and/or an OS of the computing device may include enhancing, resuming, turning on and/or switching on the electrical current to the computing device, the component of the computing device, the one or more HW and/or software SW components of the computing device, and/or the OS of the computing device; and/or to changing the computing device, the component of the computing device, the one or more HW and/or software SW components of the computing device, and/or the OS of the computing device from sleep mode, a reduced-power mode, a hibernate mode, a stand-by mode and/or any other operation mode which consumes less power than required for full operation, to operational mode, e.g., for full reception, handling, decoding, authenticating and/or processing the alert message.

Some embodiments may be used in conjunction with various devices and systems capable of processing, handling and/or delivering an alert message, for example, an alerting system, a warning system, devices and/or networks configured to operate as part of an alerting system and/or a warning system, an Integrated Public Alert & Warning System (IPAWS), devices and/or networks of an IPAWS, devices and/or networks operating in accordance with any alerting protocol, specification and/or standard, e.g., the Common Alerting Protocol (CAP) specification (Common Alerting Protocol, v. 1.1, OASIS Standard CAP-V1.1, October 2005), devices and/or networks of a Commercial Mobile Alert System (CMAS), e.g., as defined by US Code of Federal Regulation Title 47, Part 10, CMAS, devices and/or networks of a Personal Localized Alerting Network (PLAN), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless router, a wired or wireless modem, a video device, an audio device, an audio-video (A/V) device, a Set-Top-Box (STB), a broadcast HD receiver, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data sink, a Digital Still camera (DSC), a wired or wireless network, a wireless area network, a Wireless Video Area Network (WVAN), a Local Area Network (LAN), a Wireless LAN (WLAN), a Wireless Metropolitan Area Network (WMAN) communication system, a Personal Area Network (PAN), a Wireless PAN (WPAN), devices and/or networks operating in accordance with existing IEEE 802.11 standards, e.g., IEEE 802.11 (IEEE 802.11-2007: Standard for Information technology—Telecommunications and information exchange between systems—Local and metropolitan area networks—Specific requirements, Part 11: Wireless LAN Medium Access Control (MAC) and Physical Layer (PHY) Specifications—June 2007), IEEE-802.11u (IEEE 802.11u—April 2010—IEEE Standard for Information Technology—Telecommunications and information exchange between systems—Local and Metropolitan networks-specific requirements—Part II: Wireless LAN Medium Access Control (MAC) and Physical Layer (PHY) specifications: Amendment 7: Interworking with External Networks), and the like (“the 802.11 standards”), IEEE 802.16 standards, e.g., IEEE-Std 802.16, 2004 Edition, Air Interface for Fixed Broadband Wireless Access Systems, IEEE 802.16d, IEEE 802.16e (IEEE-Std 802.16e, 2005 Edition, Physical and Medium Access Control Layers for Combined Fixed and Mobile Operation in Licensed Bands), and the like (“the 802.16 standards”) and/or future versions and/or derivatives thereof, devices and/or networks operating in accordance with existing Wireless-Gigabit-Alliance (WGA) and/or WirelessHD™ specifications and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wired and/or wireless communication signals and/or systems. The wireless communication signals and/or systems may include, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other wired or wireless devices, systems and/or networks.

The term “wireless device” as used herein includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may be used to provide a wireless service.

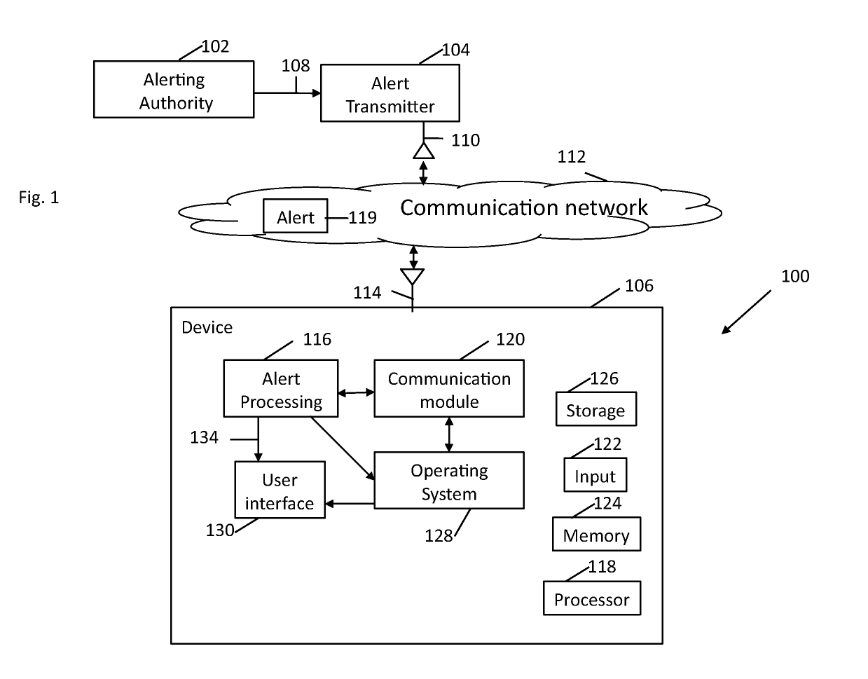

Reference is now made to FIG. 1, which schematically illustrates a block diagram of a system 100, in accordance with some demonstrative embodiments.

In some demonstrative embodiments, system may include, or may be part of, an alert and/or warning system (“alert system”), e.g., an Emergency Alert System (EAS), which may be configured to provide an alert to one or more recipients, e.g., to the public, to one or more private recipients, to a predefined group of recipients, and the like. In one example, system 100 may include, or be implemented as part of, the Integrated Public Alert & Warning System (IPAWS). For example, system 100 may include a Commercial Mobile Alert System (CMAS), which may be configured to provide services to emergency operations centers, which in turn may warn the public through geographically targeted messages, e.g., using Commercial Mobile Service Providers (CMSPs).

In some demonstrative embodiments, system 100 may include at least one alerting authority 102 capable of generating at least one alert 108, at least one alert transmitter 104 capable of transmitting at least one alert message 119 corresponding to the alert over one or more communication networks 112, and at least one device 106 capable of receiving alert message 119 from at least one communication network 112 and generating an alert indication to at least one user of device 106, e.g., as described in detail below.

In some demonstrative embodiments, alerting authority 102 may include any entity, e.g., a government entity, a public entity, a private entity, and the like. For example, alerting authority 102 may include the White House, the Police, the FBI, the National Weather Service, the U.S. Dept of Homeland Security-Federal Emergency Management Agency (DHS-FEMA), and the like. In another example, alerting authority 102 may include a private authority and alert 108 may include an alert to one or more recipients associated with the private authority, e.g., one or more subscribers to a service offered by the private authority.

In some demonstrative embodiments, alert 108 may include, for example, an emergency alert, e.g., a national emergency alert, a state emergency alert, a local alert, a territorial alert, a tribal alert, an official emergency alert, a child abduction alert (AMBER alert), and the like. The alert may relate to any situation, event, incident, and the like, e.g., a terrorist attack, a natural disaster, a public safety hazard, and the like.

In some demonstrative embodiments, alert message 119 may include an emergency alert message issued by an authorized alerting authority. For example, alert message 119 may include any message that is intended to provide at least one recipient with information regarding an emergency, and that meets the requirements for transmission by a CMSP, e.g., in accordance with the US Code of Federal Regulation Title 47, Part 10, CMAS. In other embodiments, alert message 119 may include any other alert and/or warning message including any other information issued by any other entity and/or having any other format.

In some demonstrative embodiments, alert message 119 may be formatted according to a predefined alert message format. For example, alert message 119 may include a CAP message according to the CAP specification.

In some demonstrative embodiments, communication networks 112 may include at least one wired communication network, at least one wireless communication network, and/or any combination thereof. For example, communication networks 112 may include a cellular network, an Internet network, a computer network, a television network, a telephone network, a radio network, a data network, and the like.

In some demonstrative embodiments, communication networks 112 may include at least one public data network, e.g., the Internet.

In some demonstrative embodiments, communication networks 112 may include at least one non-public communication network, e.g., a private communication network, an institutional communication network, and the like.

In some demonstrative embodiments, alert transmitter 104 may include, or may be associated with, one or more antennas to transmit alert message 119 over communication networks 112, e.g., if communication networks 112 include a wireless communication network.

In some demonstrative embodiments, alert transmitter 104 may include, or may be implemented by, one or more CMSPs, for example, as part of a CMAS. The CMAS may include a voluntary emergency alerting system, e.g., wherein CMSPs may elect to transmit Alert Messages to the public, e.g., in accordance with US Code of Federal Regulation Title 47, Part 10, CMAS.

In some demonstrative embodiments, device 106 may include or may be included as part of, for example, an electronic device, a computing device, a communication device, a wireless communication device, an electronic device, a circuit, and/or any other device. For example, device 100 may include or may be included as part of a PC, a desktop computer, a mobile computer, a laptop computer, a notebook computer, a netbook, an all-in-one device, a tablet computer, a server computer, a handheld computer, a handheld device, a PDA device, a handheld PDA device, a digital sign, an on-board device, an off-board device, a hybrid device (e.g., combining cellular phone functionalities with PDA device functionalities), a consumer device, a public device, an alerting device, a messaging device, a warning device, a vehicular device, a non-vehicular device, a mobile or portable device, a non-mobile or non-portable device, a cellular telephone, a handset, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a STB, a BD player, a BD recorder, a DVD player, a HD DVD player, a DVD recorder, a HD DVD recorder, a PVR, a broadcast HD receiver, a video source, an audio source, a video sink, an audio sink, a stereo tuner, a broadcast radio receiver, a flat panel display, a PMP, a DVC, a digital audio player, a speaker, an audio receiver, a gaming device, an audio amplifier, a data source, a data sink, a DSC, a media player, a Smartphone, a television, a music player, an AP, a base station, or the like.

Some demonstrative embodiments may be implemented to ensure that one or more alerts, e.g., emergency alerts, for example, alert 108, are provided to the public in a rapid, clear and/or reliable manner, for example, as part of an alert system e.g., the IPAWS, and/or any other alerting and/or warning system.

In some demonstrative embodiments, device 106 may be configured to receive an emergency alert message, e.g., alert message 119, issued by an authorized alerting authority, e.g., alerting authority 102, over at least one communication network, e.g., communication network 112, to authenticate the alert message using at least one embedded authentication certificate corresponding to the alerting authority, and to provide an alert indication, which is based on the alert message, to at least one user of device 106.

In some demonstrative embodiments, device 106 may be configured to detect, receive, parse, decode, authenticate, handle and/or process alert message 119, for example, within a relatively short time period, e.g., as described in detail below.

In some demonstrative embodiments, device 106 or one or more components of device 106 may implement a power management scheme to allow device to conserve power, for example, by switching between an active mode of operation and a power-save mode of operation, e.g., an “idle”, “hibernate” or “sleep” mode of operation, for example, by selectively powering down device 106 or one or more components of device 106 and/or powering up device 106 or one or more components of device 106.

In some demonstrative embodiments, device 106 may be configured to detect, receive, parse, decode, authenticate, handle and/or process alert message 119, for example, as long as there is a minimal amount of power provided to device 106, e.g., a power level sufficient for detecting and receiving alert message 119. For example, device 106 may be configured to detect, receive, parse, decode, authenticate, handle and/or process alert message 119, for example, without depending on a power state, a load state and/or a run state of device 106 and/or of a main OS of device 106, e.g., as described in detail below.

In some demonstrative embodiments, device 106 may include an alert module 116 configured to perform out-of-band and/or direct detection, reception, authentication and processing of alert message 119, e.g., as described in detail below.

In some demonstrative embodiments, device 106 may include one or more communication modules 120 to monitor, detect and/or receive alert message 119 from one or more communication networks 112. Communication modules 120 may include any wired and/or wireless communication modules. For example, communication modules 120 may include, or may be implemented as part of, one or more embedded communication devices and/or network interface cards (NIC) capable of connecting to communication networks 112 according to any communication technologies, protocols and/or standards. Communication modules 120 may include, for example, one or more wired and/or wireless transmitters, wired and/or wireless receivers and/or transceivers able to send and/or receive wired and/or wireless communication signals, frames, blocks, transmission streams, packets, messages, data items, and/or data. For example, communication modules 120 may include one or more communication modules to communicate over any wireless network, internet network, cellular network, a telephone network, a WiFi network, Worldwide Interoperability for Microwave Access (WIMAX) network, a LAN, a PAN, a WAN, a WWAN, a WPAN, a WVAN, a WMAN, WLAN, a television network, a cable network, and the like.

In some demonstrative embodiments, one or more communication modules 120 may include a plurality of communication modules, e.g., configured support a predefined number of multiple concurrent network connections. For example, a redundancy level of device 106 may be increased by communication modules 120 providing a greater number of concurrent connections to communication networks 112, e.g., at any given moment. Accordingly, the increased level of redundancy provided by device 106 may increase the chances that alert message 119 will reach the user of device 106.

In one non-limiting example, communication modules 120 may include at least one radio module capable of receiving radio signals including alert message 119, e.g., from a radio broadcast network. For example, communication modules 120 may include at least one Hybrid Digital (HD) radio module capable of receiving digital radio signals of a digital radio broadcast via radio communication channel, e.g., via a Frequency Modulation (FM) radio channel, an Amplitude Modulation (AM) radio channel, and the like. Additionally or alternatively, communication modules 120 may include at least one Digital Audio Broadcasting (DAB) module capable of receiving broadcast digital radio signals in a DAB format, e.g., in accordance with ETSI TS 102 563 V1.1.1 (2007-02): Digital Audio Broadcasting (DAB); Transport of Advanced Audio Coding (AAC) audio. Additionally or alternatively, communication modules 120 may include any other radio communication module to receive radio broadcasts of any other format. Implementing at least one radio communication module as part of device 106 may ensure that device 106 may receive alert message 119, for example even when device 106 is not connected to the Internet. Accordingly, the likelihood of device 106 receiving alert message 106 may be increased, for example, due to the longer distance and ease of connection of the radio communication module, e.g., even during an emergency when Internet and/or cellular communication systems may go down.

In some demonstrative embodiments, alert module 116 may receive alert message 119 via one or more communication modules 120.

In some demonstrative embodiments, alert module 116 and communication modules 120 may be implemented as separate elements of device 106. For example, one or more communication modules 120 may receive alert message 119 from one or more communication networks 112, and alert module 116 may receive alert message from communication modules 120. However, in other embodiments alert module 116 may be included and/or implemented as part of at least one of communication modules 120.

In some demonstrative embodiments, device 106 may include a wireless communication device, communication networks 112 may include at least one wireless communication network, and communication modules 120 may include at least one wireless communication module. In other embodiments, communication networks 112 may include at least one wired communication network or any combination of wired and wireless communication networks, and communication modules 120 may include at least one wired communication module or any combination of wired and wireless communication modules.

In some demonstrative embodiments, device 106 may also include, for example, one or more of a processor 118, an input unit 122, at least one user interface 130, a memory unit 124, and a storage unit 126. Device 106 may optionally include other hardware components and/or software components. In some demonstrative embodiments, some or all of the components of device 106 may be enclosed in a common housing or packaging, and may be interconnected or operably associated using one or more wired or wireless links. In other embodiments, components of device 106 may be distributed among multiple or separate devices.

Processor 118 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller.

In some demonstrative embodiments, device 106 may include at least one OS 128 capable of controlling and/or managing the operation and/or functionality of device 106 and/or interaction between device 106 and the user of device 106. In one example, OS 128 may be implemented by processor 118 executing OS instructions. For example, OS 128 may include a main, primary and/or standard OS (collectively referred to as “main OS”) of device 106, e.g., a Windows OS, a Meego OS, an Android OS, an Apple OS, and the like. OS 128 may include, or may be implemented by any OS-residing Application software.

Input unit 122 includes, for example, a keyboard, a keypad, a mouse, a touch-pad, a track-ball, a stylus, a microphone, or other suitable pointing device or input device.

User interface 130 may include any one or more modules and/or components capable of presenting, providing and/or delivering to one or more users of device 106 an alert corresponding to alert message 119. User interface 130 may, for example, a monitor, a screen, a flat panel display, a Cathode Ray Tube (CRT) display unit, a Liquid Crystal Display (LCD) display unit, a plasma display unit, one or more audio elements, e.g., speakers or earphones, a vibration element, an onboard resonator, a video element, or other suitable user interface and/or output devices.

Memory unit 124 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 126 includes, for example, a hard disk drive, a floppy disk drive, a Compact Disk (CD) drive, a CD-ROM drive, a DVD drive, or other suitable removable or non-removable storage units. Memory unit 124 and/or storage unit 126, for example, may store data processed by device 106.

In some demonstrative embodiments, alert module 116 may receive alert message 119 from one or more communication networks 112, e.g., via one or more communication modules 120. Alert module 116 and/or communication modules 120 may be configured to detect specific standard alert packet patterns, e.g., according to the CAP. Alert module 116 may power-up one or more elements of device 106, for example, upon detecting alert message 119, e.g., if the one or more elements are currently in a low-power state such as sleep, hibernate, shutdown, and the like. Alert module 116 may parse, authenticate and/or validate alert message 119, and alert module 116 may build and/or format one or more user-deliverable audio, visual and/or sensory alerts, and may relay the sensory alerts to user interface 130, e.g., for immediate user delivery. Alert module 116 may process alert message 119, for example, with no operating system or software application dependencies, e.g., as described in detail below.

In some demonstrative embodiments, alert module 116 may be operative independent of OS 128, to receive alert message 119 from one or more communication networks 112, to authenticate alert message 119, and/or to cause user interface 130 to provide to the user of device 106 an alert indication, which is based on alert message 119, e.g., as described in detail below.

Accordingly, alert module 116 may allow processing alert message 119, while reducing or eliminating risk of OS-related vulnerabilities, e.g., bugs, virus attacks, user intervention, slow boot time, and the like.

In some demonstrative embodiments, the alert indication may include at least one of an audio indication, a text indication, a graphic indication, a video indication, a sensual indication, for example, including any indication, e.g., a vibration indication, and/or any other suitable indication to be perceived, sensed and/or noted by the user of device 106.

In some demonstrative embodiments, alert module 116 may be operative independent of a power-mode of device 106. For example, alert module 116 may be operative to receive alert message 119 from one or more communication networks 112, to authenticate alert message 119, and/or to cause user interface 130 to provide to the user of device 106 the alert indication, for example, even if device 106 and/or OS 128 are at a non-active mode of operation, a power-save mode of operation, an “idle” mode of operation or a “sleep” mode of operation, e.g., as described in detail below.

In some demonstrative embodiments, alert module 116 may be configured to cause device 106 and/or OS 128 to switch to an active power mode, for example, based on alert message 119, e.g., upon detecting, receiving and/or authenticating alert message 119.

In some demonstrative embodiments, alert module 116 may be configured to directly access user interface 130 and to directly cause user interface 130 to provide the alert indication, e.g., as described below.

In some demonstrative embodiments, alert module 116 may include, for example, a HW alert module implemented using any HW components, a firmware alert module implemented using any firmware components, or an alert module implemented using any combination of HW and firmware components, e.g., as described below.

In some demonstrative embodiments, alert module 116 may be implemented as a single common firmware image residing on device 106, as a separate embedded firmware image residing on device 106 and communication modules 120, or as any combination thereof.

In some demonstrative embodiments, alert module 116 may be implemented by a firmware image running on a main processor of device 106, e.g., processor 118, which may be configured to support low-power operations.

In some demonstrative embodiments, alert module 116 may be implemented by a firmware image running on at least one dedicated processor and/or co-processor, e.g., other than processor 118, which may have a power state, which is independent of a power state of processor 118.

In some demonstrative embodiments, device 106 may include a common firmware module capable of serving as both a communications driver, e.g., performing the functionality of at least one communication module 120, and an alert-processing driver, e.g., performing at least part of the functionality of alert module 116. Optionally, device 106 may also include a HW module to perform another part of the functionality of alert module 116.

In some demonstrative embodiments, alert module 116 may be implemented by firmware (“alert module firmware”), which may be configured to operate independent of OS 128 and/or application software of any application executed by device 106.

In some demonstrative embodiments, alert module 116 may optionally use one or more resources of OS 128 and/or the application software, e.g., if such resources are available and running, for example, in order to reduce the time required to deliver the alert indication to the user of device 106. For example, alert module 116 may use one or more resources of OS 128 and/or the application software as in-band vehicles for best-effort delivery of the alert indication. Even though alert module 116 may be configured utilize the resources of OS 128 and/or the application software, alert module 116 may be capable of processing alert message 119, without depending on the availability and/or reliability of OS 128 and/or the application software.

In some demonstrative embodiments, alert module 116 may include, or may be associated with a non-volatile memory, e.g., a firmware non-volatile memory of the alert module firmware, to store configurable parameters and/or data for processing alert message 119, e.g., packet patterns used to detect standard emergency alerts, digital certificates used to authenticate alert messages, and the like.

In some demonstrative embodiments, alert module 116 may be configured to optionally power up one or more elements of device 106, e.g., OS 128, processor 118, user interface 130 and/or any other element of device 106, for example, if the one or more elements of device 106 are at a reduced-power mode. For example, alert module 116 may be configured to power up the one or more elements of device 106 to perform any required processing of alert message 119 and/or for providing the alert indication to the user of device 106.

In some demonstrative embodiments, a device, e.g., device 106, including an alert module, e.g., alert module 116, which is configured to process an emergency alert, e.g., alert message 119, independently of an OS of the device, e.g., OS 128, may obviate a need for running the OS of the device in order to receive, authenticate and/or deliver the emergency alert. As a result, precious, life-saving time may be gained, e.g., during critical emergencies where time is of the essence and measured in milliseconds. For example, earthquake and tsunami advanced warning systems may provide less than 20 seconds notification before strike and, accordingly, it may be desired to deliver the alert indication as quick as possible.

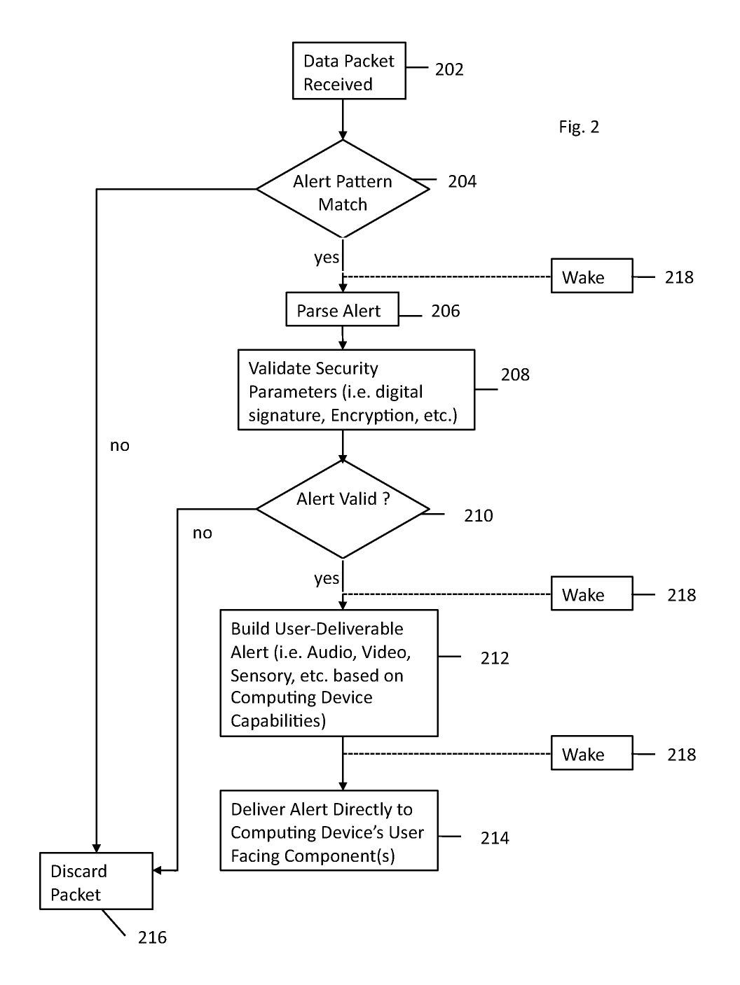

Reference is now made to FIG. 2, which schematically illustrates a method of processing an alert, in accordance with some demonstrative embodiments. In some embodiments, one or more of the operations of the method of FIG. 2 may be performed by a device, e.g., device 106 (FIG. 1); and/or an alert module, e.g., alert module 116 (FIG. 1), to process at least one alert message, e.g., alert message 119 (FIG. 1).

As indicated at block 202, the method may include receiving a data packet via at least one communication network. For example, one or more communication modules 120 (FIG. 1) may receive one or more data packets over one or more communication networks 112 (FIG. 1).

As indicated at block 204, the method may include detecting whether or not a received packet includes an alert message. The alert message may include an emergency alert message issued by an authorized alerting authority, e.g., as described above. For example, communication modules 120 (FIG. 1) may be configured to detect one or more predefined specific standard alert packet patterns, e.g., a CAP pattern, and the like.

Communication modules 120 (FIG. 1) may detect an alert message, e.g., alert message 119 (FIG. 1), for example, while device 106 (FIG. 1) is either in a low power state or running on full power. For example, communication modules 120 (FIG. 1) may be operative in the low-power state to listen-in on communication networks 112 (FIG. 1), and to detect alert message 119 (FIG. 1). In one example, communication modules 120 (FIG. 1) may utilize a WakeOnLAN or WakeOnWirelessLAN mechanism to receive and/or detect alert message 119 (FIG. 1).

As indicated at block 218, the method may include powering up one or more device elements, e.g., after detecting the alert message. The one or more elements may include a processor, e.g., device 118 (FIG. 1), an OS, e.g., OS 128 (FIG. 1), one or more applications, one or more HW elements, and the like. For example, alert module 116 (FIG. 1) may trigger a wake action to power-up OS 128 (FIG. 1), processor 118 (FIG. 1) and/or any other elements of device 106 (FIG. 1).

In some demonstrative embodiments, alert module 116 (FIG. 1) may power-up the one or more elements of device 106 (FIG. 1) upon detecting alert message 119 (FIG. 1). Alert module 116 (FIG. 1) may defer the powering-up of some or all of the elements to one or more later stages of processing alert message 119 (FIG. 1), e.g., after authenticating alert message 119 (FIG. 1) and/or after determining an alert indication corresponding to alert message 119 (FIG. 1), e.g., as described below.

The timing of powering up the one or more elements of device 106 (FIG. 1) may be configured such that an element of device 106 may be already operating, e.g., at full power or partial power, when required to process and/or handle alert message 119 (FIG. 1). The timing of powering up the one or more elements of device 106 (FIG. 1) may also be based, for example, on a power-up period required for the element to power-up from a low power state to a partial or full power state. For example, alert module 116 (FIG. 1) may be configured to power-up a first set of one or more elements of device 106 (FIG. 1), e.g., OS 128 (FIG. 1) and/or processor 118 (FIG. 1), at a first timing, e.g., upon detecting alert message 119 (FIG. 1); and to power-up a second set of one or more elements of device 106 (FIG. 1), e.g., user interface 130 (FIG. 1), at a second, different, timing, e.g., upon authenticating alert message 119 (FIG. 1) or upon alert indication corresponding to alert message 119 (FIG. 1).

Powering up the one or more elements of device 106 (FIG. 1) may enable reducing the time period between detecting alert message 119 (FIG. 1) and delivering the alert indication to the user of device 106 (FIG. 1).

As indicated at block 206, the method may include parsing and/or analyzing the alert message. For example, alert module 116 (FIG. 1) may parse and/or analyze alert message 119 (FIG. 1), e.g., utilizing predefined packet patterns to validate alert message 119 (FIG. 1).

As indicated at block 208, the method may include authenticating the alert message. For example, alert module 116 (FIG. 1) may authenticate whether or not alert message 119 (FIG. 1) is genuine. Alert module 116 (FIG. 1) may utilize, for example, one or more embedded certificates to authenticate a signature of alert message 119 (FIG. 1) and/or to decrypt the contents of alert message 119 (FIG. 1). For example, alert module 116 (FIG. 1) may authenticate alert message 119 (FIG. 1) using at least one embedded authentication certificate corresponding to alerting authority 102 (FIG. 1), e.g., as described above.

As indicated at block 210, the method may include determining whether or not the received alert message is valid, for example, based on whether or not the alert message is successfully authenticated.

In some demonstrative embodiments, the method may include powering up one or more device elements, for example, if the alert message is successfully authenticated, e.g., as described above with reference to block 218.

As indicated at block 216, the method may include discarding the received packet, for example, if an alert message is not detected in the received packet, or if authentication of the alert message fails.

As indicated at block 212, the method may include defining a user-deliverable alert indication to be provided to a user of the device. For example, alert module 116 (FIG. 1) may extract pertinent alert information from alert message 119 (FIG. 1), e.g., including parameters defining alert information to be provided to the user, parameters defining the alert indication to be provided to the user, and the like. Alert module 116 (FIG. 1) may define a user-deliverable alert indication based on the extracted alert information. For example, the alert indication may be defined to include one or more of text, graphics, audio, video and/or sensory indication and/or message.

In some demonstrative embodiments, the alert indication may be based on the content of alert message 119 (FIG. 1). For example, alert message 119 (FIG. 1) may include predefined alert content, e.g., in the form of text, graphics, video and/or audio, and alert module 116 (FIG. 1) may define the alert indication to include the predefined alert content. For example, the predefined alert content may include a predefined alert message, e.g., “hurricane alert”, “earthquake alert”, and the like.

In some demonstrative embodiments, the method may include powering up one or more device elements, for example, after defining the alert indication, e.g., as described above with reference to block 218. For example, alert module 116 (FIG. 1) may power-up user interface 130 (FIG. 1) to be used for delivering the alert indication.

As indicated at block 214, the method may include delivering the alert indication to a user of the device. For example, alert module 116 (FIG. 1) may cause at least one user interface 130 (FIG. 1) to deliver the alert indication to at least one user of device 106 (FIG. 1). For example, alert module 116 (FIG. 1) may define the alert indication in a format suitable for delivery by user interface 130 (FIG. 1) and may propagate the alert indication to user interface 130 (FIG. 1) for final delivery. The delivery of the alert indication may be performed, for example, at a full power, pre-OS boot stage.

In some demonstrative embodiments, alert module 116 (FIG. 1) may have a direct hardware access to user interface 130 (FIG. 1) enabling alert module 116 (FIG. 1) to directly control user interface 130 (FIG. 1) to deliver the alert indication, e.g., immediately or within a short delay. In one non-limiting example, user interface 130 (FIG. 1) may include a display and alert module 116 (FIG. 1) may utilize a Management Engine (ME), for example, in the form of a direct ME-to-Graphics controller path to include the alert indication as part of a graphic overlay (“SPRITE”) that is drawn directly to the display.

In some demonstrative embodiments, alert module 116 (FIG. 1) my utilize the direct hardware access to cause user interface 130 (FIG. 1) to deliver the alert indication, for example, even if device 106 (FIG. 1), OS 128 (FIG. 1) and/or user interface 130 (FIG. 1) are not operating at full power level. Alternatively, alert module 116 (FIG. 1) may choose to defer the delivery of the alert indication, e.g., until OS 128 (FIG. 1) is capable of controlling user interface 130 (FIG. 1) to deliver the alert indication.

In some demonstrative embodiments, alert module 116 (FIG. 1) may be configured to process the delivery of the alert indication at an out of band operation, e.g., independently from, and/or without relying on, OS 128 (FIG. 1), for example, in order to save processing time and/or to increase the time the user of device 106 has to respond to the alert indication. In one non-limiting example, alert module 116 (FIG. 1) may utilize an out-of-band mechanism similar to the Intel Advanced Management Technology (AMT).

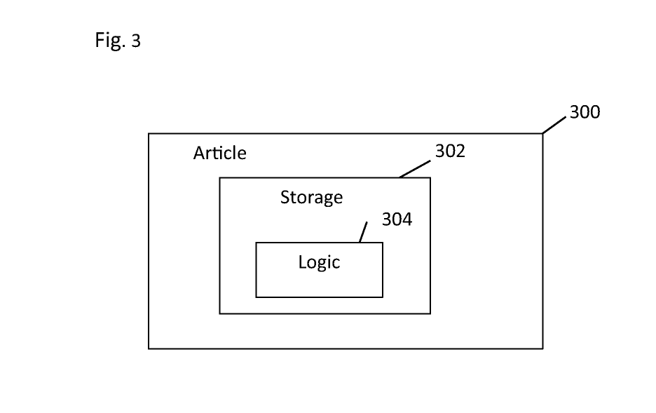

Reference is made to FIG. 3, which schematically illustrates an article of manufacture 300, in accordance with some demonstrative embodiments. Article 300 may include a machine-readable storage medium 302 to store logic 304, which may be used, for example, to perform at least part of the functionality of alert module 116 (FIG. 1), and/or to perform one or more operations of the method of FIG. 2.

In some demonstrative embodiments, article 300 and/or machine-readable storage medium 302 may include one or more types of computer-readable storage media capable of storing data, including volatile memory, non-volatile memory, removable or non-removable memory, erasable or non-erasable memory, writeable or re-writeable memory, and the like. For example, machine-readable storage medium 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A device comprising:
an alert module, operative independent of an operating-system of said device, to receive an alert message from at least one communication network, and to cause at least one user interface of said device to provide to a user of said device an alert indication, which is based on said alert message.

2. The device of claim 1, wherein said alert module is operative regardless of a power-mode of said device.

3. The device of claim 2, wherein said alert module is to cause said device to switch to an active power mode based on said alert message.

4. The device of claim 1 comprising at least one communication module to receive said alert message from said at least one communication network, wherein said alert module is to receive said alert message from said communication module.

5. The device of claim 4, wherein said at least one communication module comprises a plurality of communication modules to simultaneously monitor a plurality of communication channels for detecting said alert message.

6. The device of claim 1, wherein said alert indication comprises at least one of an audio indication, a text indication, a graphic indication, a video indication and a sensual indication.

7. The device of claim 1, wherein said alert module is to directly access said user interface to directly cause said user interface to provide said alert indication.

8. The device of claim 1, wherein said alert module comprises hardware.

9. The device of claim 1, wherein said alert module comprises firmware.

10. The device of claim 1, wherein said alert module is to authenticate the alert message.

11. The device of claim 1, wherein said communication network comprises a public data network.

12. The device of claim 1, wherein said device comprises a wireless communication device and said communication network comprises a wireless communication network.

13. The device of claim 1, wherein said alert indication is based on a content of said alert message.

14. The device of claim 1, wherein said alert message comprises an emergency alert message issued by an authorized alerting authority.

15. The device of claim 1, wherein said alert message comprises an alert message of a common-alerting-protocol (CAP).

16. A device comprising:
an alert module, operative independent of a power-mode of said device, to receive an alert message from at least one communication network and to cause at least one user interface of said device to provide an alert indication, which is based on said alert message, to a user of said device.

17. The device of claim 16, wherein said alert module is operative independent of an operating-system of said device.

18. The device of claim 16, wherein said alert module is to cause said device to switch to an active power mode based on said alert message.

19. The device of claim 16 comprising at least one communication module to receive said alert message from said at least one communication network, wherein said alert module is to receive said alert message from said communication module.

20. The device of claim 16, wherein said alert module is to directly access said user interface to directly cause said user interface to provide said alert indication.

21. The device of claim 16, wherein said alert module comprises firmware.

22. The device of claim 16, wherein said communication network comprises a public data network.

23. The device of claim 16, wherein said alert message comprises an emergency alert message issued by an authorized alerting authority.

24. A system comprising:
a device to receive an emergency alert message issued by an authorized alerting authority over at least one communication network, to authenticate the alert message using at least one authentication certificate corresponding to said alerting authority, and to provide an alert indication, which is based on said alert message, to a user of said device.

25. The system of claim 24, wherein said device is to receive said emergency alert message, to authenticate said alert message and to provide said alert indication regardless of a power-mode of said device.

26. The system of claim 24, wherein said device is to switch to an active power mode based on said alert message.

27. A method comprising:
receiving at a device an emergency alert message issued by an authorized alerting authority over at least one communication network;
authenticating the alert message using at least one authentication certificate corresponding to said alerting authority; and
causing at least one user interface of said device to provide an alert indication, which is based on said alert message, to a user of said device.

28. The method of claim 27 comprising performing said receiving, authenticating and causing independent of at least one of an operating-system of said device and a power-mode of said device.

29. The method of claim 27 comprising powering up one or more elements of said device after receiving said alert message.

30. The method of claim 27 comprising simultaneously monitoring a plurality of communication channels for detecting said alert message.
